(19) United States
(12) Patent Application Publication
(10) Pub. No.: US 2023/0324869 A1
(43) Pub. Date: Oct. 12, 2023

(54) AUTOMATION FIELD DEVICE FOR USE IN A POTENTIALLY EXPLOSIVE AREA

(71) Applicant: Endress+Hauser SE+Co. KG, Maulburg (DE)

(72) Inventors: Bernd Strütt, Steinen (DE); Christian Strittmatter, Rickenbach (DE); Simon Gerwig, Schopfheim (DE)

(21) Appl. No.: 18/043,961

(22) PCT Filed: Aug. 16, 2021
(86) PCT No.: PCT/EP2021/072673

§ 371 Date: Mar. 3, 2023

(30) Foreign Application Priority Data
Sep. 8, 2020 (DE) 10 2020 123 407.4

(51) Int. Cl. G05B 19/042

(52) U.S. Cl. CPC G05B 19/0428

(57) ABSTRACT

An automation field device for use in a potentially explosive area comprises: two connecting terminals for connecting a two-wire line via which a current can be supplied; a sensor and/or actuator element for capturing and/or setting a process variable; a field device electronic system connected to the connecting terminals and designed to provide a power supply for the field device on the basis of the supplied current and also to transmit or receive, by means of the two-wire line, the process variable captured by means of the sensor element and/or a process variable to be set by the actuator element; and an explosion protection unit incorporated in a current path between the two connecting terminals to limit a possible short-circuit current and which comprises the at least two diodes in series and at least one resistor connected in parallel to the at least two diodes.

The invention relates to an automation field device for use in a potentially explosive area.

In automation, field devices serving to record and/or modify process variables are frequently used, particularly in process automation. Sensors, such as fill-level measuring devices, flow meters, pressure and temperature measuring devices, pH redox potential meters, conductivity meters etc., are used for recording the respective process variables, such as fill level, flow, pressure, temperature, pH level, and conductivity. Actuators, such as, for example, valves or pumps, are used to influence process variables. The flow rate of a fluid in a pipeline section or a fill level in a container can thus be altered by means of actuators. In principle, all devices that are used in-process and that supply or process process-relevant information are referred to as field devices. In the context of the invention, field devices also include remote I/Os, radio adapters, and/or, in general, devices that are arranged at the field level.

A variety of such field devices is manufactured and marketed by the Endress+Hauser company.

Many field devices are available in so-called 2-wire versions. Power is here supplied to the field device by means of the same pair of lines (two-wire line) used for communication.

Especially in the process industry, but also in automation, physical or technical variables must often be measured or determined by the field devices in areas in which there is potentially a risk of explosion, so-called potentially explosive areas. By means of suitable measures in the field devices and evaluation systems (e.g. voltage and current limitation), the electrical power in the signal to be transmitted can be limited such that this signal cannot trigger an explosion under any circumstances (short-circuit, interruptions, thermal effects, etc.). For this purpose, corresponding protection principles have been defined in IEC EN DIN 60079 ff.

According to this standard, design and circuitry measures for the field devices for use in explosive atmospheres are defined on the basis of the ignition protection types to be applied. One of these ignition protection types is represented by the ignition protection type “intrinsic safety” (identification code Ex-i, IEC EN DIN 60079-11, published June 2012).

The ignition protection type “intrinsic safety” is based on the principle of limiting current and voltage in a circuit. The power in the circuit which could be capable of igniting an explosive atmosphere is limited such that the surrounding explosive atmosphere cannot be ignited either by sparks or by impermissible heating of the electrical components.

A critical area in which a possible ignition of the surrounding explosive atmosphere can occur is the connecting terminals of a field device to which the two-wire line is connected.

A short-circuit current that can act on the connecting terminals is therefore usually limited using an explosion protection unit. The explosion protection units known from the prior art usually comprise at least two, but generally three, diodes connected in series, which serve to decouple large capacitors (C>100 nF). However, this has the disadvantage that the diodes create a voltage drop even in the case of low currents, which in turn results in a lower voltage and thus less power being available to internal field device electronic systems.

This can be shown using a simple example. Assuming a 4-20 mA field device, which has 3.6 mA current available in fault condition and is to be operated with a supply voltage of 10.6 V, the power at the connecting terminals will be 38.16 mW.

If three diodes are used in series and a relatively low forward voltage of the diodes of 150 mV is assumed, there will still be a loss of 0.54 mW at each diode. In the case of three diodes connected in series, this corresponds to a power loss of 1.62 mW. This means that 4.25% (=1.62 mW/(3.6 mA*10.6 V)=1.62 mW/38.16 mW) of the energy available at the diodes would be lost.

The invention is therefore based on the object of proposing a field device comprising an explosion protection unit which has a lower power loss.

The object is achieved according to the invention by the automation field device according to claim 1.

The automation field device according to the invention for use in a potentially explosive area comprises:
two connecting terminals for connecting a two-wire line via which a current can be supplied;
a sensor and/or actuator element for capturing and/or setting a process variable;
a field device electronic system which is connected to the connecting terminals, and to which the current that can be supplied via the two-wire line is supplied, and which is designed to provide a power supply for the field device on the basis of the supplied current and also to transmit or receive, by means of the two-wire line, the process variable captured by means of the sensor element and/or a process variable to be set by the actuator element; and
as part of the field device electronic system, an explosion protection unit which is incorporated in a current path between the two connecting terminals in order to limit a possible short-circuit current and which comprises the at least two diodes in series and at least one resistor connected in parallel to the at least two diodes.

An advantageous embodiment of the field device according to the invention provides that the at least two diodes and the at least one resistor are coordinated with one another such that, below an inflection point of an output voltage (Uout) provided downstream of the explosion protection unit, a power loss is substantially determined by the at least one resistor and above the inflection point the power loss is substantially determined by the at least two diodes, wherein the inflection point lies in particular in the range of 0.1-6 volts, preferably in the range of 0.2-4 volts, particularly preferably in the range of 0.3-2.5 volts.

An advantageous embodiment of the field device according to the invention provides that the at least two diodes and the at least one resistor are further coordinated with one another such that a power loss below the inflection point is less than a power loss above the inflection point.

An advantageous embodiment of the field device according to the invention provides that the at least one resistor has a resistance value in the range of 10-100 ohms, preferably 15-60 ohms, particularly preferably 30-35 ohms, very particularly preferably approximately 33 ohms.

An advantageous embodiment of the field device according to the invention provides that the at least two diodes in each case have a forward voltage of approximately 0.3 V.

The invention is explained in more detail on the basis of the following drawings. The following are shown:

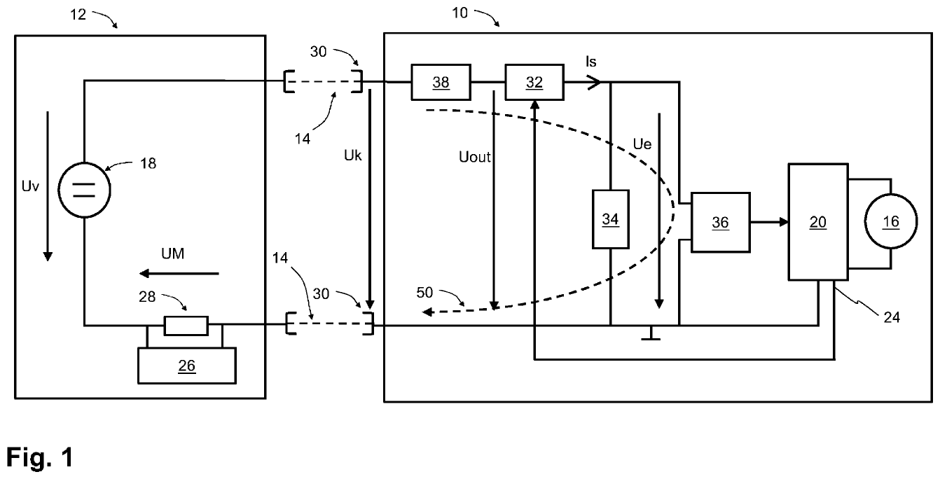

FIG. 1: a schematic representation of a field device which is connected to a higher-level via a two-wire line for signal and power transmission,

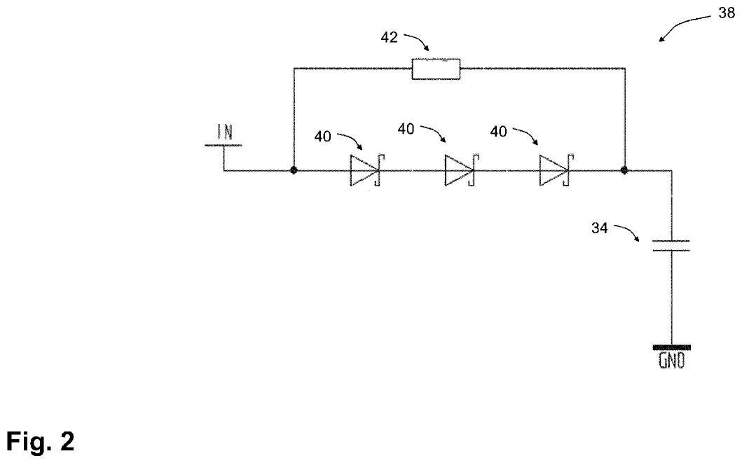

FIG. 2: the explosion protection unit in detail, and

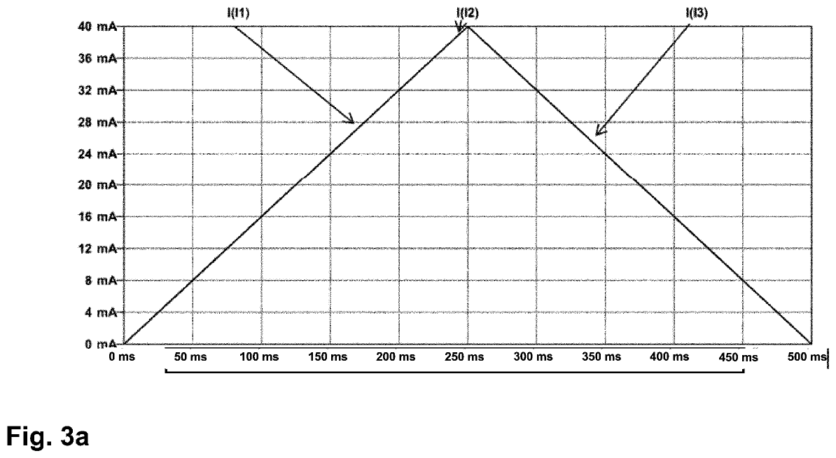

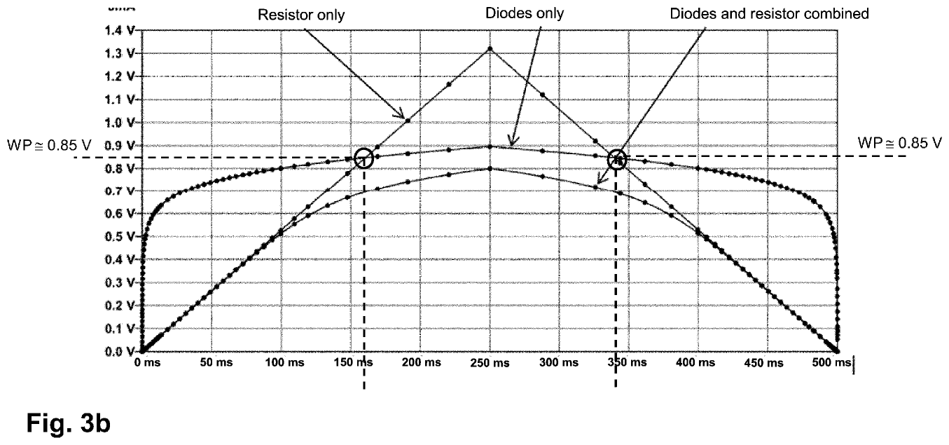

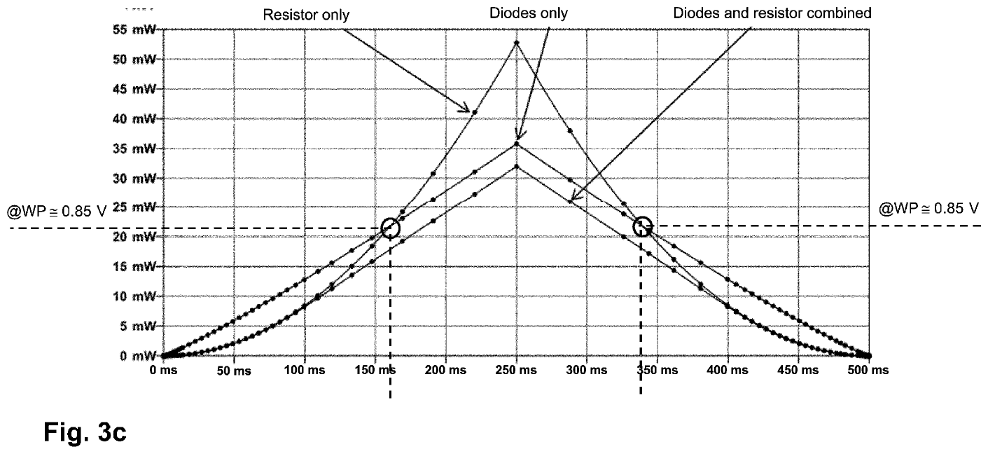

FIGS. 3a-3c: circuit simulations of the explosion protection unit.

FIG. 1 shows a schematic representation of a field device 10, which is connected to a higher-level 12 via a two-wire line 14 for signal and power transmission. In the example shown, the field device 10 is a measuring point in which a measured value or process variable (for example temperature, pressure, humidity, fill level, flow) is captured with the aid of a sensor 16. However, the field device could also be an actuator point in which a process variable is set with the aid of an actuator.

The field device 10 does not contain its own power source, but rather draws the supply current required for its operation via the two-wire line 14. This can be provided, for example, by a voltage source 18 contained in the higher-level unit 12. A measured value signal representing the measured value just measured is transmitted from the field device 10 to the higher-level unit 12 via the same two-wire line 14. In accordance with a conventional technique, the measured value signal is a signal current Is flowing via the two-wire line 14, which can change between two prespecified values (usually the current values 4 mA and 20 mA). The voltage source 18 supplies a DC voltage Uv, and the measuring current Is is a direct current.

For detecting a measured value, the field device 10 contains the aforementioned sensor 16 and a transducer circuit 20 connected thereto, which emits signals representing the captured measured value at an output 22.

The higher-level unit 12 contains an evaluation circuit 26 which obtains the measured value information from the signal current Is transmitted via the two-wire line 14. For this purpose, a measuring resistor 28 is inserted into the two-wire line, at which a voltage UM is generated, which is proportional to the signal current Is transmitted via the two-wire line and which is supplied to the evaluation circuit 26.

The signal current Is is set in the field device 10 by a controllable current regulator or current sink 32, to which the signal emitted by the transducer circuit 20 at the output 24 is supplied as a control signal for the signal current Is to be defined. Depending on the measured value detected in each case, the signal current Is flowing in the two-wire line is set by a corresponding control of the current regulator or current sink 32. The current regulator or current sink can comprise, for example, a transistor which is controlled by the transducer circuit 20 via the control signal.

As can be seen from FIG. 1, the field device 10 also contains a voltage source 34 and a voltage regulator 36, for example in the form of a switching or linear regulator, the task of which is to generate as constant an operating voltage as possible for the transducer circuit 20 and the sensor 16. The input voltage for the voltage regulator 36 is supplied by the voltage source 34. The voltage source 34 can be a capacitor, for example. The use of the voltage regulator 36 in conjunction with the voltage source 34 makes it possible to provide the transducer circuit 20 and the sensor 16 at all times with the highest possible power. The voltage regulator 36 ensures that, despite an increase in its input voltage Ue, the operating voltage of the transducer circuit 20 and the sensor 16 is kept at a constant value, so that a higher input power is available by increasing the input voltage Ue at the voltage regulator 36, which thus also enables a higher output power.

If the measured value detected by the sensor 16 is at the lower end of the measured value range, the signal current Is will also assume the lower value of the signal current range. In the usual 4-20 mA technology, therefore, a value of 4 mA. Correspondingly, if the measured value detected by the sensor 16 is at the upper end of the measured value range, the signal current Is will assume the upper value of the signal current range. In the usual 4-20 mA technology, therefore, a value of 20 mA.

Furthermore, the field device 10 comprises an explosion protection unit 38, which is arranged between the controllable current source and one of the connecting terminals in the current path of Is. In FIG. 1, the explosion protection unit 38 is arranged between the upper connecting terminal 30 and the controllable current regulator or current sink 32. The explosion protection unit 38 can, however, also be arranged in the field device behind the lower connecting terminal.

The explosion protection unit 38 makes it possible to use the field device 10 in the potentially explosive areas mentioned at the outset, since the short-circuit current is reduced to a non-critical level by the explosion protection unit.

FIG. 2 shows an explosion protection unit 38 designed according to the invention. This comprises three diodes 40 connected in series with one another and a resistor 42 which is arranged or connected in parallel with the series connection of the diodes. The power loss can be reduced by the combination of the series connection of the diodes 40 and the resistor 42 connected in parallel thereto. This is to be explained using the following example. By way of example, it is assumed that the resistor has a value of 33 ohms. In this case, continuing with the example mentioned above (Is=3.6 mA and Uk=10.6 V), there would be a voltage drop across the resistor of 118.8 mV and thus a power loss of 0.427 mW. This would mean that the power loss would have been reduced by 74%. The three diodes are connected in parallel with the resistor 42 in order to avoid a disproportionate increase in the power loss due to the current dependency of the resistor, i.e. as the current increases, the voltage drop also increases. Without the diodes 40 connected in parallel, with a maximum current Is of 22 mA and a resistor with 33 ohms, there would be a power loss of 15.972 mW. In order not to accept these losses, the three diodes 40 are still connected in series in the circuit. In this state, the power loss would be 9.9 mW.

For clarification, a circuit simulation for the explosion protection unit 38 is shown in FIGS. 3a-3c. The voltage, the current and the power loss across the explosion protection unit were simulated over time. The explosion protection unit 38 was simulated once with just a resistor (i.e. without the diodes connected in parallel), once with just the three diodes connected in series (i.e. without the resistor connected in parallel) and once with the combination according to the invention of the three diodes 40 connected in series and the resistor 42 connected in parallel thereto as a limitation measure. FIG. 3a shows only the current Is compared to the time at which the corresponding circuit was simulated.

As a result of the circuit simulation, it can be seen from FIG. 3b that, with the limitation measure using just the diodes connected in series, a voltage drop across the explosion protection unit up to an inflection point at approximately 0.85 V is greater than with a limitation measure using just the resistor.

After the inflection point at approximately 0.85 V, the behavior changes and the voltage drop across the explosion protection unit which consists of just the resistor increases compared to the explosion protection unit which consists of the diodes. The same behavior is accordingly also apparent for a power loss of the explosion protection unit and is shown in FIG. 3c. As a result, the power available at the output of the explosion protection unit changes accordingly, i.e. in the case of an explosion protection unit consisting only of diodes compared to an explosion protection unit consisting of just the resistor, there is less power available at the output of the explosion protection unit up to the inflection point and more power after the inflection point.

FIGS. 3a-3c also show the result of the circuit simulation for an explosion protection unit designed according to the invention and consisting of a resistor and three diodes connected in parallel thereto. The circuit simulation shown in FIG. 3c shows that the combination of the two limitation methods (resistor and diodes connected in parallel thereto) provides the maximum output power over a very large range of 0-40 mA.

### LIST OF REFERENCE SIGNS

10 Field device
12 Higher-level unit, e.g. programmable logic controller (PLC)
14 Two-wire line
16 Sensor
20 Transducer circuit
24 Output of the transducer circuit
30 Connecting terminal
32 Controllable current regulator or current sink
34 Power storage element
36 Voltage regulator, e.g. switching regulator or linear regulator
38 Explosion protection unit
40 Diodes of the explosion protection unit
42 Resistor of the explosion protection unit
Ue Voltage at the output of the storage element
Is Measuring current
Uk Terminal voltage
WP Inflection point

1-5. (canceled)

6. An automation field device for use in a potentially explosive area, comprising:
two connecting terminals for connecting a two-wire line via which a current can be supplied;
a sensor and/or actuator element for detecting and/or setting a process variable;
a field device electronic system which is connected to the connecting terminals and to which the current that can be supplied via the two-wire line is supplied and which is designed to provide a power supply for the field device on the basis of the supplied current) and also to transmit or receive, by means of the two-wire line, the process variable captured by the sensor element and/or a process variable to be set by the actuator element; and
as part of the field device electronic system, an explosion protection unit which is incorporated in a current path between the two connecting terminals to limit a possible short-circuit current and which includes the at least two diodes in series and at least one resistor connected in parallel to the at least two diodes.

7. The automation field device according to claim 6, wherein the at least two diodes and the at least one resistor are coordinated with one another such that, below an inflection point of an output voltage provided downstream of the explosion protection unit, a power loss is determined by the at least one resistor and above the inflection point the power loss is determined by the at least two diodes, wherein the inflection point lies in particular in the range of 0.1-6 volts.

8. The automation field device according to claim 7, wherein the at least two diodes and the at least one resistor are further coordinated with one another such that a power loss below the inflection point is less than a power loss above the inflection point.

9. The automation field device according to claim 6, wherein the at least one resistor has a resistance value in the range of 10-100 ohms.

10. The automation field device according to claim 6, wherein the at least two diodes (40) each have a forward voltage of approximately 0.3 V.
